(19) United States
(12) Patent Application Publication
(10) Pub. No.: US 2023/0229582 A1
(43) Pub. Date: Jul. 20, 2023

(54) INFORMATION PROCESSING APPARATUS, PROCESSING METHOD FOR INFORMATION PROCESSING APPARATUS, AND STORAGE MEDIUM

(71) Applicant: CANON KABUSHIKI KAISHA, Tokyo (JP)

(72) Inventor: KAZUHIRO YOSHIMURA, Kanagawa (JP)

(21) Appl. No.: 18/153,244

(22) Filed: Jan. 11, 2023

(30) Foreign Application Priority Data
Jan. 18, 2022 (JP) 2022-005831

(51) Int. Cl. G06F 11/36

(52) U.S. Cl. CPC G06F 11/3636; G06F 11/3664

(57) ABSTRACT

An information processing apparatus includes a code execution unit that executes a source code and a resource opening unit that opens resources included in an open resource list in a case where there is no difference between resources used for executing the source code and the open resource list.

### BACKGROUND

### Field

The present disclosure relates to an information processing apparatus, a processing method for the information processing apparatus, and a storage medium.

### Description of the Related Art

Recent years have seen the increase in the use of cloud computing systems in which users utilize information processing environments of service providers via networks instead of having their own information processing apparatuses for executing applications. There have been provided shopping systems for commodity transactions, video distribution systems, and other diverse types of services through the Internet by using cloud computing systems. Cloud computing systems make it easier to allocate and release computing resources and largely reduce burdens on the server-side management, and will remain a standard of system development in the future. In system development utilizing a cloud computing system, services and systems provided by cloud vendors can be collaborated. For this reason, it is common to use original libraries and Application Programming Interfaces (APIs) provided by cloud vendors.

To build a system operating in collaboration with cloud services, programs will be available based on original APIs and libraries provided by cloud vendors. Because cloud vendors can typically perform version upgrades more than 1,000 times a year, it is important to select and use optimal services in system development utilizing a cloud computing system. Accordingly, a system developer needs to be familiar with the structure and usage (libraries and APIs) of the latest service and new usages of existing services. In reality, however, one system developer can, at best, be familiar with a handful of services, resulting in a problem of a number of processes required in debugging and troubleshooting for services each system developer is not familiar with.

To overcome the problem of the increase in the number of debugging processes, it is common to use a debugger for automatically identifying and solving source code errors. Japanese Patent Application Laid-Open No. 2018-532169 discusses a technique for sharing debugging information about debugger-based debugging between a plurality of system developers to reduce the number of debugging processes to be performed by system developers.

The technique discussed in Japanese Patent Application Laid-Open No. 2018-532169, however, has a problem of a security risk arising from disclosing debugging information to a plurality of parties participating in system development.

### SUMMARY

The present disclosure is directed to minimizing a security risk by opening only necessary resources.

According to an aspect of the present disclosure, an information processing apparatus includes a code execution unit configured to execute a source code and a resource opening unit configured to open resources included in an open resource list in a case where there is no difference between resources used for executing the source code and the open resource list.

Further features of the present disclosure will become apparent from the following description of exemplary embodiments with reference to the attached drawings.

### BRIEF DESCRIPTION OF THE DRAWINGS

FIG. 1 is a block diagram illustrating an example hardware configuration of a development supporting apparatus.

FIG. 2 is a block diagram illustrating an example functional configuration of the development supporting apparatus.

FIG. 3 is a flowchart illustrating processing.

FIG. 4 illustrates an example configuration of a system.

FIG. 5 is a flowchart illustrating processing of the system.

FIGS. 6A and 6B illustrate an error code to be acquired by a source code acquisition unit.

FIGS. 7A to 7C illustrate resource lists to be updated by a resource list update unit.

FIG. 8 is another block diagram illustrating an example functional configuration of the development supporting apparatus.

FIG. 9 is another flowchart illustrating processing.

### DESCRIPTION OF THE EMBODIMENTS

Exemplary embodiments will be described in detail below with reference to the accompanying drawings. Configurations described in the following exemplary embodiments are to be considered as illustrative, and are not seen to be limiting. The exemplary embodiments are described with respect to where the developer of a particular source code is aware of errors/bugs in the source code and requests another party to debug the source code in question. However, any other situation where aspects of the present disclosure can be applied/implemented are applicable.

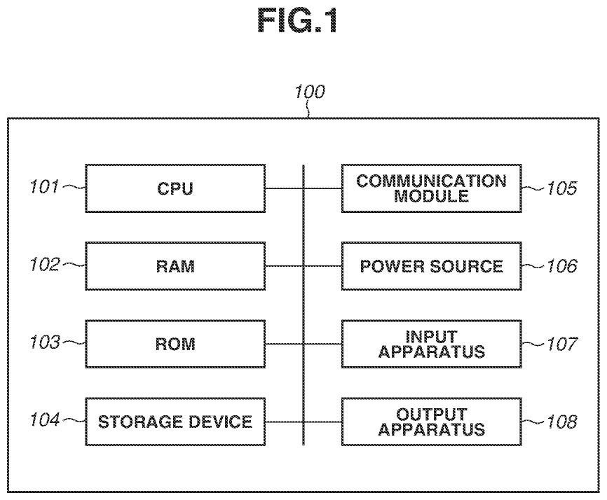

A series of processing including acquiring a source code containing errors, opening resources, resolving errors, and ending the resource opening will be described below with reference to FIGS. 1 to 7C.

FIG. 1 is a block diagram illustrating an example hardware configuration of a development supporting apparatus 100 according to a first exemplary embodiment. The development supporting apparatus 100 is an example of an information processing apparatus. Components of the development supporting apparatus 100 will be described below with reference to FIG. 1.

The development supporting apparatus 100 is, for example, a computer including a central processing unit (CPU) 101, a random access memory (RAM) 102, a read only memory (ROM) 103, a storage device 104, a communication module 105, a power source 106, an input apparatus 107, and an output apparatus 108.

The CPU 101, which is a processor that executes calculation processing, can be a single CPU or a multi-CPU. The CPU 101 needs to be able to process tasks on a thread basis.

The CPU 101 executes a program stored in the ROM 103 by using the RAM 102 as a work memory.

The storage device 104 is a storage medium for storing programs to be executed by the CPU 101 and data to be processed by the CPU 101. The storage device 104 can be a Hard Disk Drive (HDD) or a Solid State Drive (SSD).

The communication module 105 is a communication interface for connecting the development supporting apparatus 100 to an external entity, such as a cloud service. The development supporting apparatus 100 inputs and outputs data to be stored in the RAM 102 and the storage device 104 by using the communication module 105. It is desirable that the communication module 105 has two different input/output ports: a control port and a data transmission port.

The power source 106, which is a power supply module of the development supporting apparatus 100, can have a plurality of redundancies or can be rechargeable. The input apparatus 107 inputs a direct command to the development supporting apparatus 100 via a keyboard or a mouse. The output apparatus 108 displays information to the user via a monitor.

### [Processing in Development Supporting Apparatus 100]

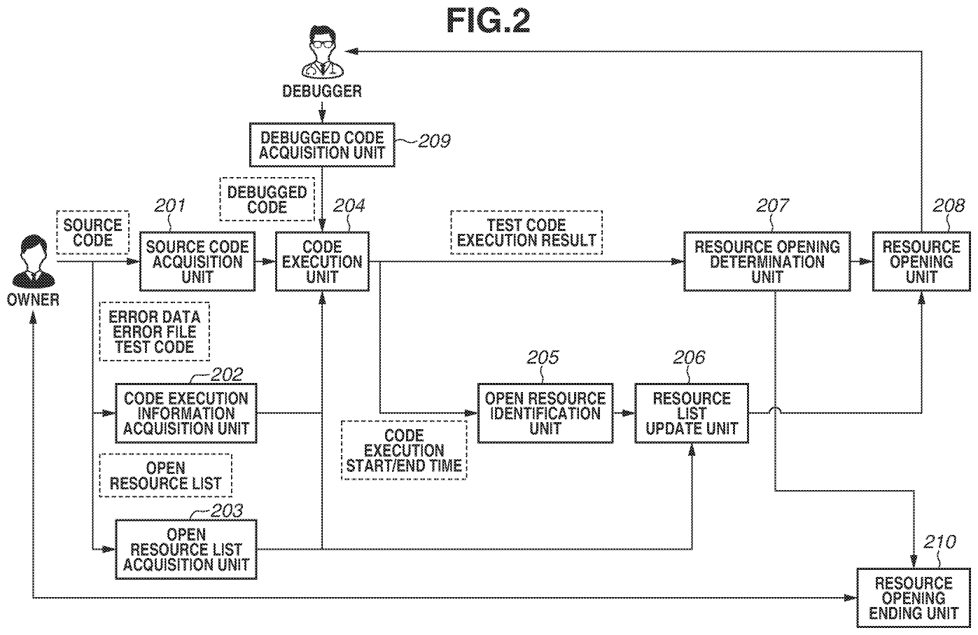

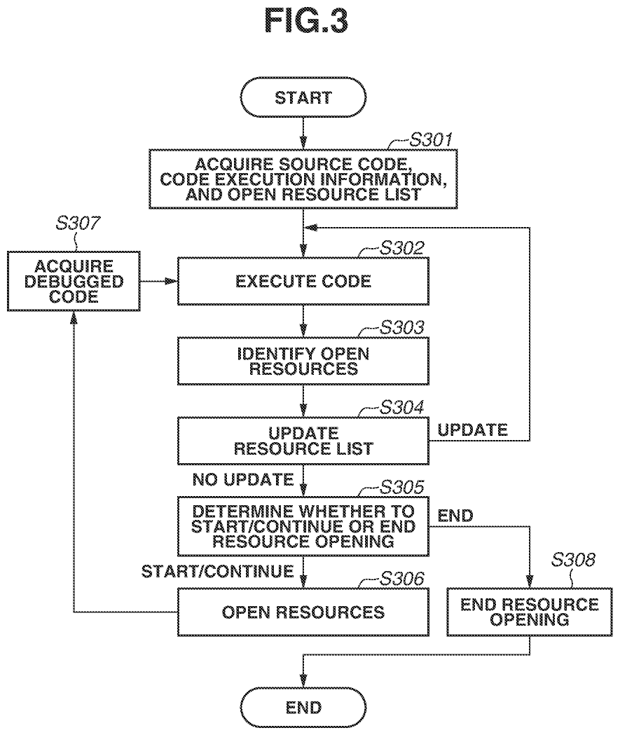

Processing to be performed by the development supporting apparatus 100 according to the present exemplary embodiment will be described below with reference to FIGS. 2 and 3.

FIG. 2 is a block diagram illustrating an example functional configuration of the development supporting apparatus 100 according to the first exemplary embodiment. The development supporting apparatus 100 includes a source code acquisition unit 201, a code execution information acquisition unit 202, an open resource list acquisition unit 203, a code execution unit 204, an open resource identification unit 205, and a resource list update unit 206. The development supporting apparatus 100 also includes a resource opening determination unit 207, a resource opening unit 208, a debugged code acquisition unit 209, and a resource opening ending unit 210.

The development supporting apparatus 100 implements the function of each unit in FIG. 2 when the CPU 101 reads a control program stored in the ROM 103 and executes the program. The development supporting apparatus 100 can be configured to include a dedicated processing circuit corresponding to each component unit. Processing performed by each component unit will be described below.

FIG. 3 is a flowchart illustrating a processing method for the development supporting apparatus 100 according to the first exemplary embodiment. In step S301, the source code acquisition unit 201 acquires the source code, including an error, that requires debugging, the code execution information acquisition unit 202 acquires code execution information, and the open resource list acquisition unit 203 acquires an open resource list that can be opened to the public from an owner who requested the debugging to be conducted. While the present embodiment describes that the owner of the source code and execution information is the entity requesting that debugging occur, this is not seen to be limiting, and any entity can provide the necessary information for a debugging procedure to occur.

The code execution information refers to data required to execute the source code, and includes a test code, correct-answer data of the test code, error data required for test execution, and an error file. The open resource list refers to a resource list that can be opened to the public, which is specified by the owner and required for debugging. The open resource list includes a database, a file, and a related code other than the source code that includes the error.

A system built by the owner according to the present exemplary embodiment will now be described. The system will be described as “an Extract/Transform/Load (ETL) processing system that acquires a device log and executes ETL processing on a log file”. The above-described source code that includes the error is a part of the ETL processing system. Upon completion of debugging of error locations, the ETL processing system that can execute the log ETL processing will be completed.

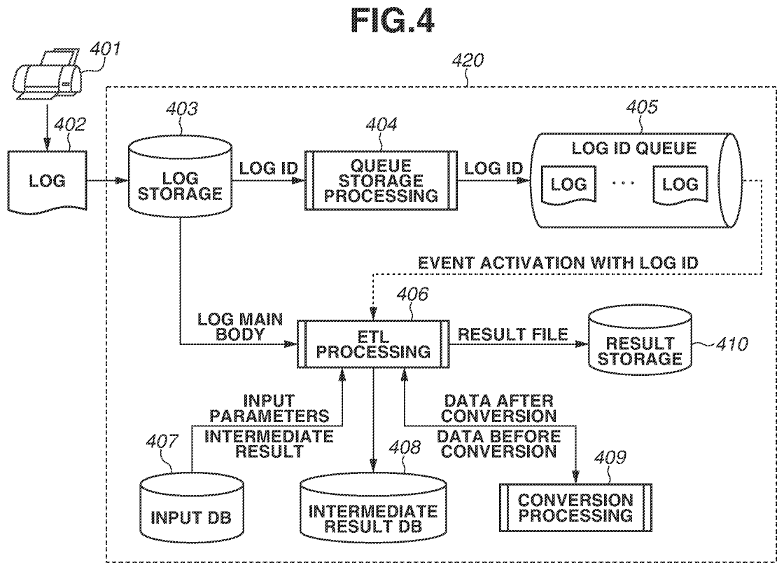

FIG. 4 illustrates an example configuration of an ETL processing system 420.

The development supporting apparatus 100 is connectable to the ETL processing system 420 and can acquire information about the ETL processing system 420. The ETL processing system 420 includes a log storage 403, a queue storage processing function 404, a log identification (ID) queue 405, an ETL processing function 406, an input database 407, an intermediate result database 408, a conversion processing function 409, and a result storage 410. The ETL processing system 420 is activated when a log 402 of a device 401 is stored in the log storage 403.

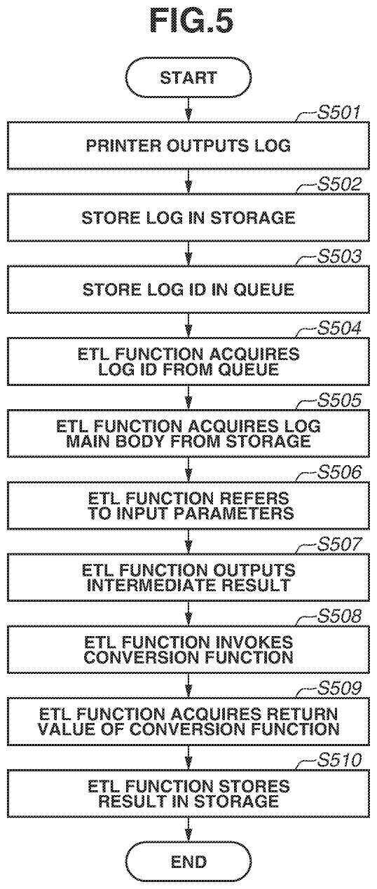

FIG. 5 is a flowchart illustrating the processing of the ETL processing system 420. In step S501, the device (e.g., a printer) 401 outputs the log 402. In step S502, the log storage 403 stores the log 402. The queue storage processing function 404 is invoked when the log 402 is stored. In step S503, the queue storage processing function 404 stores, in the log ID queue 405, the log ID of the log 402 stored in the log storage 403.

In step S504, the ETL processing function 406 acquires the log ID from the log ID queue 405. The processing in step S504 can be performed as part of the above-described processing flow or can start upon occurrence of a timer event after a predetermined time period has elapsed.

In step S505, the ETL processing function 406 acquires the log 402 from the log storage 403 based on the acquired log ID. In step S506, the ETL processing function 406 refers to input parameters from the input database 407. In step S507, the ETL processing function 406 outputs an intermediate result of the ETL processing to the intermediate result database 408.

In step S508, the ETL processing function 406 starts (invokes) the conversion processing function 409. In step S509, the ETL processing function 406 acquires the return value from the conversion processing function 409. In step S510, the ETL processing function 406 stores an ETL processing result file in the result storage 410. The processing then ends.

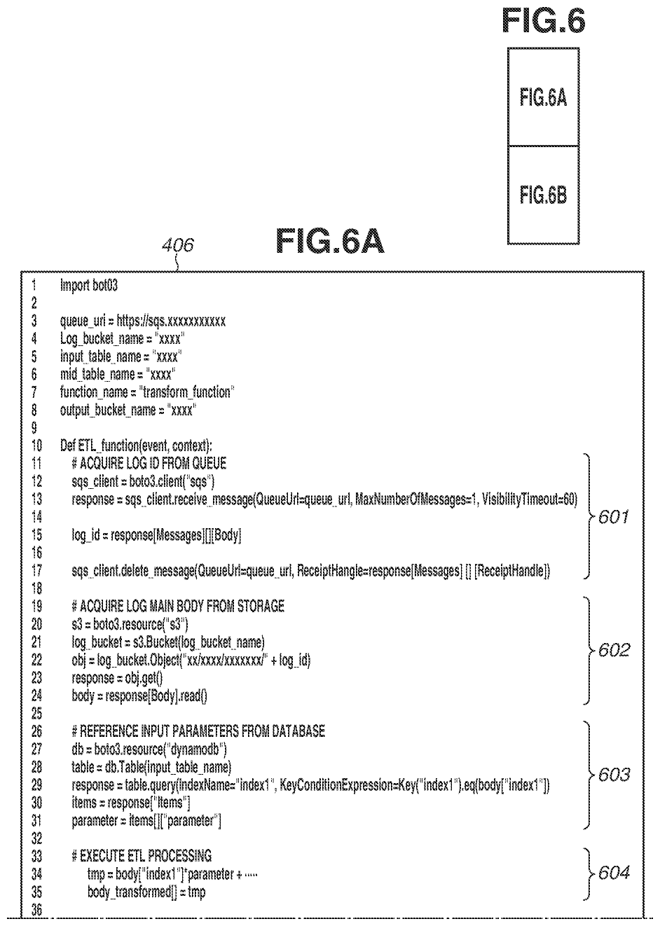

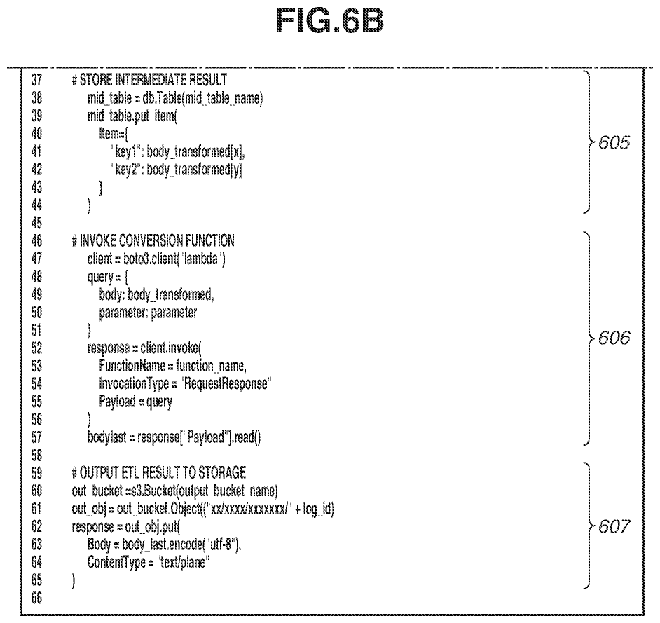

FIGS. 6A and 6B illustrate an example code as the entity of the ETL processing function 406. The ETL processing function 406 first acquires the log ID from the log ID queue 405 by implementing via a code 601, and then acquires the log 402 from the log storage 403 by implementing a code 602.

The ETL processing function 406 then refers to the input parameters from the input database 407 by implementing a code 603, executes a part of the ETL processing by using the input parameters by implementing a code 604, and then stores the intermediate result of the ETL processing in the intermediate result database 408 by implementing a code 605. The ETL processing function 406 invokes the conversion processing function 409 by implementing a code 606, and then stores the ETL processing result file in the result storage 410 by implementing a code 607.

According to the present exemplary embodiment, the code as the entity of the ETL processing function 406 is source code containing errors. When errors are resolved, the processing is executed up to the end of the code 607, and the ETL processing result file is output to the result storage 410. According to the present exemplary embodiment, the owner wants to implement the ETL processing of the log 402 acquired from the device 401 by using the above-described ETL processing system 420 and the above-described code. Errors, however, are contained in the code, and the ETL processing of the log 402 has not yet been implemented.

Returning to the description of FIGS. 2 and 3, in step S302, the code execution unit 204 executes the test code contained in the code execution information acquired from the code execution information acquisition unit 202. The test code contains processing for starting the source code acquired from the source code acquisition unit 201. For the test code, confirmation that all of errors and bugs contained in the source code have been resolved is needed. According to the present exemplary embodiment, an error is contained in the code 604. In this stage, the processing stops between steps S506 and S507 even after the test code is executed.

The resources that can be used by the code execution unit 204 are only the resources included in the open resource list acquired from the open resource list acquisition unit 203. Limiting the resources that can be used by the code execution unit 204 can prevent users other than the owner from contacting resources as secret information and unnecessary resources.

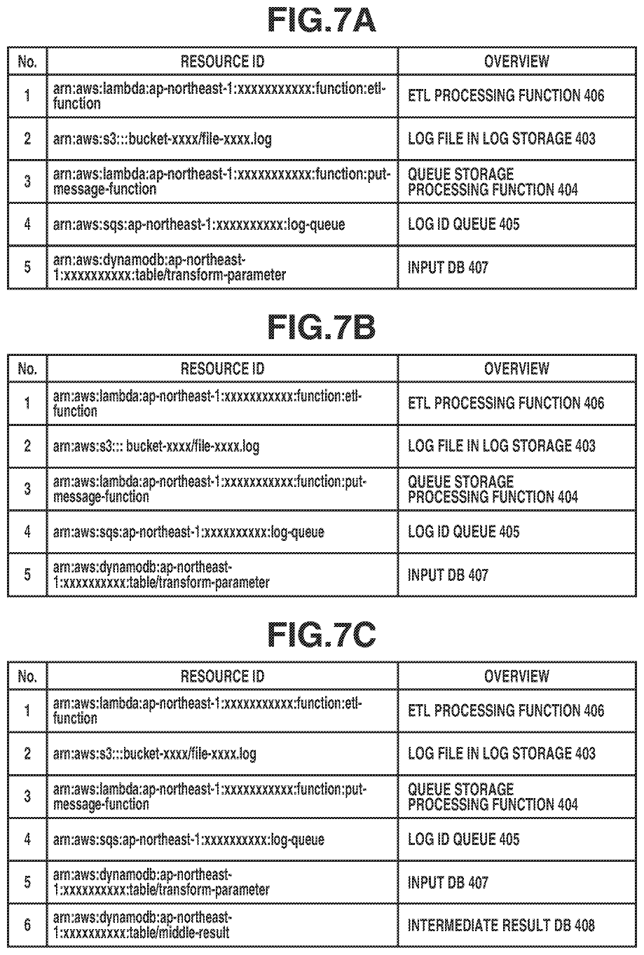

FIG. 7A illustrates an example open resource list according to the present exemplary embodiment. Because the processing has advanced up to step S506, the resources to be accessed by the code execution unit 204 up to the processing in step S506 are included in the open resource list in FIG. 7A.

According to the present exemplary embodiment, resources that can be used by users other than the owner are limited by increasing or decreasing the number of rights to be provided to the debugger that executes the code in the code execution unit 204. More specifically, at this timing, the code execution unit 204 is provided the right to access the ETL processing function 406, the log file in the log storage 403, the queue storage processing function 404, the log ID queue 405, and the input database 407. The code execution unit 204 outputs the result of the code execution based on the provided access rights to the resource opening determination unit 207. For example, the result of the code execution is “1” in a case where all of errors and bugs contained in the source code have been resolved, or the result of the code execution is “0” in a case where any error or bug remains unsolved in the source code. The code execution unit 204 also outputs the code execution processing start time and end time to the open resource identification unit 205.

In step S303, the open resource identification unit 205 identifies, based on the code execution processing start time and end time acquired from the code execution unit 204, the resources used in code execution in step S302. According to the present exemplary embodiment, an activity monitoring service represented by Cloud Trail from Amazon Web Service (AWS) is adopted as an exemplary method for identifying the resources used in code execution. The activity monitoring service records account activities of the entire infrastructure in a log, continuously monitors the account activities, and retains the log. In this way, an activity that can cause the vulnerability of security can be detected and retroactive troubleshooting can be performed

According to the present exemplary embodiment, the open resource identification unit 205 identifies the resources used in code execution based on the log recorded by the activity monitoring service, and outputs a resource list. More specifically, the open resource identification unit 205 identifies the resources with which an activity is confirmed from the time when the source code processing is started in step S302 to the time when the processing ends because of an error as resources used in code execution.

According to the present exemplary embodiment, the open resource identification unit 205 identifies the resources used in code execution based on the log recorded by such an activity monitoring unit as the activity monitoring service. The resource identification method, however, is not limited to the above-described method. For example, the open resource identification unit 205 can perform the above-described method by pre-registering a specific code with a resource access occurrence and then analyzing the source code for the appearance of the registered code. The open resource identification unit 205 outputs a resource list of the identified resources to the resource list update unit 206.

In step S304, the resource list update unit 206 acquires the resource list from the open resource identification unit 205 and the open resource list from the open resource list acquisition unit 203, and updates the resource list used in code execution in step S302.

The open resource list acquired from the open resource list acquisition unit 203 is a list of the resources, pre-specified by the owner, that can be opened to the public.

As described above, FIG. 7A illustrates an example of an open resource list. FIG. 7B illustrates an example of a resource list identified by the open resource identification unit 205. According to the present exemplary embodiment, there is no difference between the open resource list in FIG. 7A and the identified resource list in FIG. 7B at this timing, and hence the resource list update unit 206 does not update the identified resource list. In a case where the identified resource list is not updated (NO UPDATE in step S304), the processing proceeds to step S305. Processing to be performed in a case where the identified resource list is updated is described below. The resource list update unit 206 outputs the identified resource list to the resource opening unit 208 regardless of whether the identified resource list is updated.

In step S305, the resource opening determination unit 207 confirms whether all errors and bugs contained in the source code have been resolved based on the result of the code execution by the code execution unit 204 to determine whether to start and continue the resource opening or end the resource opening. In a case where the result of the code execution is “0”, the resource opening determination unit 207 determines to start and continue the resource opening. In a case where the result of the code execution is “1”, the resource opening determination unit 207 determines to end the resource opening.

While in the present exemplary embodiment the resource opening determination unit 207 determines the resource opening based only on the result of the code execution by the code execution unit 204, the determining method is not limited to the above-described method. For example, the resource opening determination unit 207 compares a result of correct-answer code execution pre-acquired from the code execution information acquisition unit 202 with a result of the code execution acquired from the code execution unit 204 to determine the resource opening based on whether the results match. In a case where the resource opening determination unit 207 determines to start and continue the resource opening (START/CONTINUE in step S305), the processing proceeds to step S306. In a case where the resource opening determination unit 207 determines to end the resource opening (END in step S305), the processing proceeds to step S308.

As described above, because the processing stops between steps S506 and S507 (an error occurs), the processing proceeds to step S306.

In step S306, the resource opening unit 208 opens the resources to the debugger based on the resource list acquired from the resource list update unit 206. More specifically, the resource opening unit 208 provides the rights corresponding to the open resource list to the debugger to implement the resource opening. According to the present exemplary embodiment, the resource opening unit 208 provides the right to view and change the resource ID of Nos. “1” to “5” to the debugger based on the identified resource list in FIG. 7B.

While in the present exemplary embodiment one type of debugger is involved, the development supporting apparatus 100 can include a debugger type determination unit (not illustrated) and the resource opening unit 208 can change the rights to be provided to the debugger depending on the type of debugger. In a case where a plurality of types of debuggers exist, such as an in-house debugger, an outside novice debugger, or an outside veteran debugger, the resource opening unit 208 provides the right to view and change the resource ID to the in-house debugger and only provides the right to view the resource ID to the outside debuggers.

The resource opening unit 208 notifies the debugger of information about the provided rights via electronic mail or web display. The debugger determines the information about the provided rights, and performs debugging within the scope of the provided rights to debug the code. While in the present exemplary embodiment the resource opening unit 208 implements the resource opening by providing the rights to the debugger, the opening method is not limited to the above-described method. For example, the resource opening unit 208 can duplicate the resources to be opened in another environment, and then open the duplicated environment to the debugger. Alternatively, before opening the resources, the resource opening unit 208 can identify and mask portions corresponding to secret information for the resources and codes to be opened.

In step S307, the debugged code acquisition unit 209 acquires the debugged code from the debugger. According to the present exemplary embodiment, the debugger debugs the code in a state where the processing stops between steps S506 and S507 of the flowchart in FIG. 5. While the debugged code enables the processing to advance, the processing stops between steps S507 and S508.

After the code is debugged so that the processing proceeds to the step for accessing the intermediate result database 408, the debugger attempts to access the intermediate result database 408 upon execution of the debugged code. At this timing, however, the intermediate result database 408 is not included in the open resource list in FIG. 7A, and the debugger has no right to access the intermediate result database 408. Thus, the debugger cannot access the intermediate result database 408, resulting an error. A log of an attempt to access the intermediate result database 408 is recorded in the above-described activity monitoring service. The open resource list acquisition unit 203 adds, based on the log, the intermediate result database 408 to the open resource list in FIG. 7A. Then, the open resource list acquisition unit 203 outputs the open resource list including the added intermediate result database 408 to the code execution unit 204 and the resource list update unit 206.

The debugged code acquisition unit 209 outputs the debugged code acquired from the debugger to the code execution unit 204. Then, the processing proceeds to step S302.

In step S302, as described above, the code execution unit 204 executes the test code on the debugged code acquired by the debugged code acquisition unit 209.

In step S303, as described above, the open resource identification unit 205 identifies, based on the code execution processing start time and end time acquired from the code execution unit 204, the resources used in code execution in step S302. The identified resource list at the above-described timing illustrated in FIG. 7B is changed to the identified resource list at this timing illustrated in FIG. 7C. The intermediate result database 408 is added to the identified resource list in FIG. 7B, resulting in the identified resource list in FIG. 7C.

In step S304, unlike the above-described processing, the resource list update unit 206 compares the last identified resource list (FIG. 7B) with the present identified resource list (FIG. 7C) to determine whether there is a difference between the two resource lists. As described above, the open resource list output by the open resource list acquisition unit 203 is the same as the resource list in FIG. 7C. In the first instance of the processing in step S304, the resource list update unit 206 compares the open resource list with the identified resource list. In subsequent instances of the processing in step S304 the resource list update unit 206 compares the last identified resource list with the present identified resource list.

Because there is a difference between the last and the present identified resource lists unlike the above-described processing, the resource list update unit 206 determines that the identified resource list is updated (UPDATE in step S304). Then, the processing returns to step S302 instead of proceeding to step S305.

Subsequently, as in the above-described processing, the processing proceeds to steps S302, S303, and then S304. After the resource list update unit 206 confirms that there is no difference between the last and the present identified resource lists (NO UPDATE in step S304), the processing proceeds to step S305.

In step S305, as described above, the resource opening determination unit 207 starts and continues, or ends the resource opening based on the result of the code execution by the code execution unit 204. At this timing, because the processing stops between steps S507 and S508, the result of the code execution is “0”. Accordingly, the resource opening determination unit 207 determines to continue the resource opening (START/CONTINUE in step S305). Then, the processing proceeds to step S306.

As described above, in step S306, the resource opening unit 208 opens the resources to the debugger based on the resource list acquired from the resource list update unit 206. According to the present exemplary embodiment, the resource opening unit 208 provides the right to view and change the resource ID of Nos. “1” to “6” to the debugger based on the identified resource list in FIG. 7C. Then, the processing proceeds to step S307.

The debugger debugs the source code containing errors by repeating the above-described processing. The resource opening unit 208 changes, based on the debugging, the resource list to be opened. The debugging continues by increasing number of resources to be opened. When the debugging is completed, in step S302, the code execution unit 204 executes the test code on the debug completion code. The result of the code execution becomes “1”. Accordingly, the resource opening determination unit 207 determines to end the resource opening based on the result of the code execution by the code execution unit 204 (END in step S305). Then, the processing proceeds to step S308.

In step S308, the resource opening ending unit 210 ends the resource opening based on the result of the determination, “End resource opening”, by the resource opening determination unit 207. More specifically, the resource opening ending unit 210 ends the resource opening by withdrawing the rights provided to all of the debuggers. At this timing, the resource opening ending unit 210 needs to withdraw the rights from the debugger with successful debugging as well as from all of the other debuggers.

In a case where the resource opening is to end, the resource opening ending unit 210 also notifies the owner that the resource opening is completed. In this way, the processing is performed by the development supporting apparatus 100 according to the present exemplary embodiment.

As described above, in step S302, the code execution unit 204 executes the source code. More specifically, the code execution unit 204 executes the test code for implementing the test of the source code.

In a case where there is no difference between the resources used in code execution by the code execution unit 204 and the open resource list (NO UPDATE in step S304), the processing proceeds to step S306 via step S305. In step S306, the resource opening unit 208 opens the resources included in the open resource list.

The resource opening unit 208 opens the resources included in the open resource list depending on the result of the code execution by the code execution unit 204. In a case where the result of the code execution by the code execution unit 204 is a result of the code execution in a case where the source code contains bugs (START/CONTINUE in step S305), the processing proceeds to step S306. In step S306, the resource opening unit 208 opens the resources included in the open resource list.

In step S302, in a case where the source code is debugged, the code execution unit 204 executes the debugged source code. In a case where there is no difference between the resources used in the last execution by the code execution unit 204 and the resources used in the present execution by the code execution unit 204 (NO UPDATE in step S304), the processing proceeds to step S306 via step S305. In step S306, the resource opening unit 208 opens the resources included in the open resource list.

The resources that can be used by the code execution unit 204 are the resources included in the open resource list. In a case where the code execution unit 204 attempts to use a resource not included in the open resource list, the resource attempted to be used is added to the open resource list.

In a case where there is a difference between the resources used in the last execution and the resources used in the present execution (UPDATE in step S304), the processing returns to step S302. In step S302, the code execution unit 204 re-executes the above-described debugged source code.

In a case where the result of the code execution by the code execution unit 204 is a result of the code execution in a case where the source code contains no bug (END in step S305), the processing proceeds to step S308. In step S308, the resource opening ending unit 210 ends the resource opening.

In step S306, the resource opening unit 208 opens the resources by providing the right to reference the resources to the debugger. The resource opening unit 208 can open the resources by duplicating the resources in another environment. The resource opening unit 208 can also open the resources in a state where the resources included in the open resource list are partly hidden. The resource opening unit 208 can also change the resources to be opened depending on the type of the debugger that debugged the source code.

According to the present exemplary embodiment, the development supporting apparatus 100 can, in debugging in a cloud computing system, just open the minimum resources necessary for debugging to the debugger. This enables the development supporting apparatus 100 to efficiently debugging while minimizing security risks.

According to the first exemplary embodiment, it is possible to provide the debugger with an easy-to-debug environment while securing security by limiting the resources to be opened depending on the progress of debugging by the debugger. The first exemplary embodiment does not address the security risk that an unnecessary resource is added without permission when a malicious debugger participates in debugging. A second exemplary embodiment addresses this.

According to the second exemplary embodiment, a debugged code check processing is added between the debugged code acquisition processing in step S307 and the code execution processing in step S302 in FIG. 3. Differences between the second exemplary embodiment and the first exemplary embodiment will be described below.

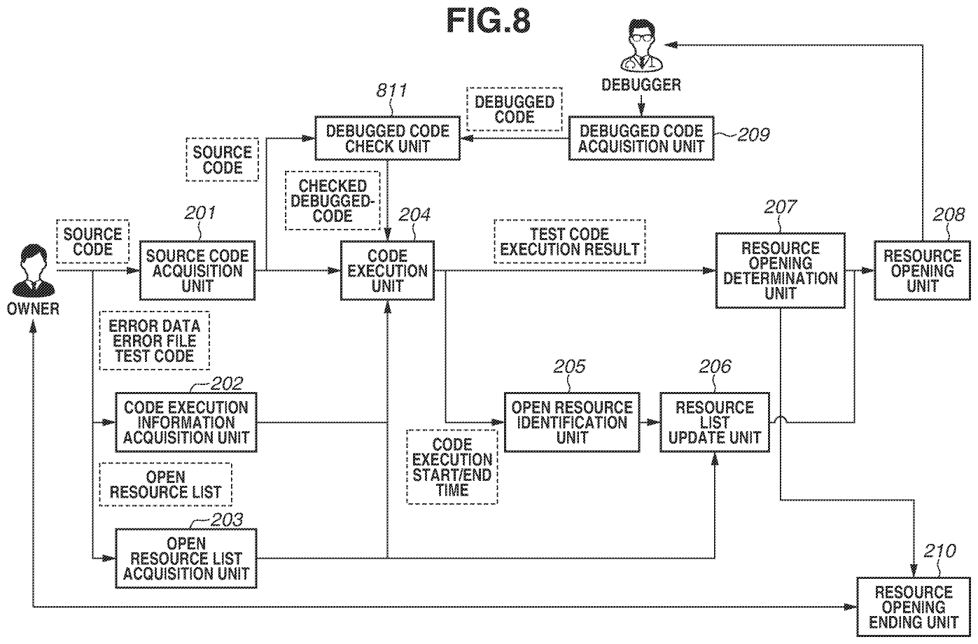

FIG. 8 is a block diagram illustrating an exemplary functional configuration of the development supporting apparatus 100 according to the second exemplary embodiment. FIG. 8 illustrates the functional configuration illustrated in FIG. 2 plus a debugged code check unit 811. The debugged code check unit 811 is located between the debugged code acquisition unit 209 and the code execution unit 204. The debugged code acquisition unit 209 outputs the debugged code acquired from the debugger to the debugged code check unit 811. The source code acquisition unit 201 outputs the source code acquired from the owner to the code execution unit 204 and the debugged code check unit 811. The debugged code check unit 811 outputs the checked debugged-code to the code execution unit 204 based on the source code and the debugged code. The code execution unit 204 executes the test code on the checked debugged-code.

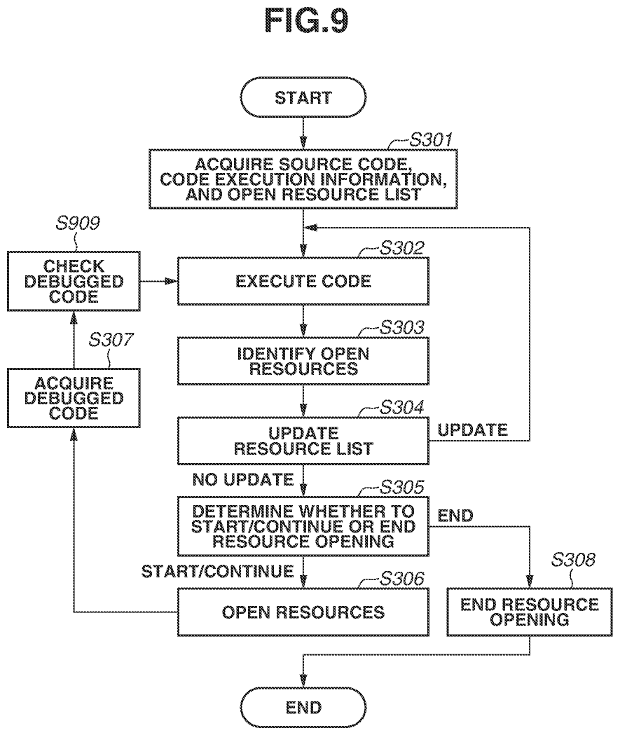

FIG. 9 is a flowchart illustrating a processing method performed by the development supporting apparatus 100 according to the second exemplary embodiment. FIG. 9 illustrates the flowchart in FIG. 3 plus step S909. Step S909 is located between steps S307 and S302.

After completion of step S307, the processing proceeds to step S909. In step S909, the debugged code check unit 811 inputs the debugged code acquired by the debugged code acquisition unit 209 and the source code acquired by the source code acquisition unit 201, and checks the debugged code based on the debugged and the source codes. More specifically, the debugged code check unit 811 checks whether there a security risk exists in the debugged code based on the difference between the debugged code and the source code.

In the debugged code check processing performed in step S909 after the initial processing is performed, the debugged code check unit 811 checks the debugged code based on the last debugged code instead of the source code.

More specifically, processing performed in step S909 after the initial processing is performed, the debugged code check unit 811 checks the present debugged code based on the present and the last debugged codes. More specifically, the debugged code check unit 811 checks whether there a security risk exists in the present debugged code based on the difference between the present and the last debugged codes.

The debugged code check unit 811 determines whether the code including a predetermined security risk is contained in the difference. In a case where the code including the predetermined security risk is contained in the difference, the debugged code check unit 811 notifies the debugger of information “This debugging is inapplicable”. Then, the processing proceeds to step S307. In a case where the code including the predetermined security risk is not contained in the difference, the debugged code check unit 811 outputs the checked debugged-code to the code execution unit 204. Then, the processing returns to step S302. The debugged code check unit 811 repeats the processing, similar to the processing in FIG. 3.

Examples of codes including a predetermined security risk include code for connecting with an external network or code for deleting a file. In a case where these codes are contained in the difference, the debugged code check unit 811 determines that the debugged code is inapplicable.

While the debugged code check unit 811 checks the debugged code by confirming whether a predetermined code is contained in the above-described difference, this is not seen to be limiting. Examples of methods that can be implemented by the debugged code check unit 811 include a method for predetermining resources that can be added and not permitting a debugged code for adding other resources or a method for permitting a debugged code for adding a resource only in a case where errors are corrected.

As described above, the debugged code check unit 811 checks whether a security risk exists in the debugged source code. More specifically, the debugged code check unit 811 checks whether a code including a security risk exists in the difference between the source code before the debugging and the source code after the debugging. Examples of codes including a security risk include code for connecting with an external network or code for deleting a file. A code including a security risk is a code for adding a resource other than the predetermined resources. In a case where no security risk exists in the above-described debugged source code, the code execution unit 204 executes the debugged source code.

According to the present exemplary embodiment, the development supporting apparatus 100 can prevent the application of a debugged code for adding a code including a security risk. This enables the development supporting apparatus 100 to prevent an unnecessary resource from being added without permission when a malicious debugger participates in debugging.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, these embodiments are not seen to be limiting. The scope of the following claims is to be accorded the broadest interpretation so as to encompass all such modifications and equivalent structures and functions.

This application claims the benefit of Japanese Patent Application No. 2022-005831, filed Jan. 18, 2022, which is hereby incorporated by reference herein in its entirety.

What is claimed is:

1. An information processing apparatus comprising:
a code execution unit configured to execute a source code; and
a resource opening unit configured to open resources included in an open resource list in a case where there is no difference between resources used for executing the source code and the open resource list.

2. The information processing apparatus according to claim 1, wherein the resource opening unit opens the resources included in the open resource list based on a result of execution of the source code.

3. The information processing apparatus according to claim 2, wherein the resource opening unit opens the resources included in the open resource list in a case where the result of the execution of the source code execution is a result of the execution of the source code execution the source code contains a bug.

4. The information processing apparatus according to claim 3, further comprising a resource opening ending unit configured to end opening the resource in a case where the result of the execution of the source code is a result of the execution of the source code when the source code does not contain a bug.

5. The information processing apparatus according to claim 1,
wherein, in a case where the source code is debugged, the code execution unit executes the debugged source code, and
wherein the resource opening unit opens the resources included in the open resource list in a case where there is no difference between the resources used in a last execution by the code execution unit and the resources used in a present execution by the code execution unit.

6. The information processing apparatus according to claim 5, wherein the resource opening unit changes the resources to be opened depending on a type of debugger used to debug the source code.

7. The information processing apparatus according to claim 5, further comprising a debugged code checking unit configured to check whether the debugged source code has a security risk.

8. The information processing apparatus according to claim 7, wherein the debugged code checking unit checks whether the difference between the source code before debugging and the source code after debugging contains a code including a security risk.

9. The information processing apparatus according to claim 8, wherein the source code including a security risk is code for connecting with an external network or code for deleting a file.

10. The information processing apparatus according to claim 8, wherein the source code including a security risk is code for adding a resource other than predetermined resources.

11. The information processing apparatus according to claim 7, wherein the code execution unit executes the debugged source code in a case where the debugged source code has no security risk.

12. The information processing apparatus according to claim 5, wherein the code execution unit re-executes the debugged source code in a case where there is a difference between the resources used in the last execution and the resources used in the present execution.

13. The information processing apparatus according to claim 1,
wherein resources usable by the code execution unit are the resources included in the open resource list, and
wherein, in a case where the code execution unit attempts to use a resource not included in the open resource list, the resource attempted to be used is added to the open resource list.

14. The information processing apparatus according to claim 1, wherein the code execution unit executes a test code for testing the source code.

15. The information processing apparatus according to claim 1, wherein the resource opening unit opens the resources by providing the right to reference the resources.

16. The information processing apparatus according to claim 1, wherein the resource opening unit opens the resources by duplicating the resources in another environment.

17. The information processing apparatus according to claim 1, wherein the resource opening unit opens the resources in a state where the resources included in the open resource list are partly hidden.

18. A method for an information processing apparatus, the method comprising:
executing a source code; and
opening resources included in an open resource list in a case where there is no difference between resources used for executing the source code and the open resource list.

19. A non-transitory storage medium storing a program causing an information processing apparatus to execute a method, the method comprising:
executing a source code; and
opening resources included in an open resource list in a case where there is no difference between resources used for executing the source code and the open resource list.
